(19) United States
(12) Patent Application Publication
(10) Pub. No.: US 2006/0185689 A1
(43) Pub. Date: Aug. 24, 2006

(54) Transportable holding tank for stripe removal system

(76) Inventor: James P. Crocker, Stuart, FL (US)

Correspondence Address: MCHALE & SLAVIN, P.A., 2855 PGA BLVD, PALM BEACH GARDENS, FL, 33410, US

(21) Appl. No.: 11/340,738

(22) Filed: Jan. 26, 2006

Related U.S. Application Data
(63) Continuation-in-part of application No. 10/884,643, filed on Jul. 2, 2004.

(51) Int. Cl. B08B 3/02

(52) U.S. Cl. 134/10; 134/21; 15/320; 15/321; 15/302

(57) ABSTRACT

A transportable holding tank for containing clean water and for accepting waste from a stripe removal system. The holding tank is carried on a flatbed vehicle and requires less deck space, thus effectively increasing the cargo-carrying capacity of the vehicle compared with that available if the vehicle were carrying a conventional round or elliptical holding tank. Construction of the tank enables the holding tank to withstand a partial vacuum imposed for pumping waste into the tank. Hooks secured inside of the tank permit a bag for separating solid waste from liquid waste for easy disposal of semi dried materials.

### RELATED APPLICATIONS

This application is a continuation-in-part of Ser. No. 10/884,643, filed Jul. 2, 2004 and entitled “Stripe Removal System”, the contents of which are incorporated herein in their entirety.

### FIELD OF THE INVENTION

This invention relates to the field of high pressure water cleaning devices for highways, runways, parking decks, and other hard surfaces.

### PRIOR ART BACKGROUND

The use of paint stripes on road surfaces is the accepted method to indicate vehicle lanes, crossing lanes, parking areas and numerous other indicators. Various pavement marking techniques are known, including the use of traffic paint, thermoplastic, epoxy paint and preformed tapes. Common pavement surfaces are asphalt and concrete. Most pavement marking systems are intended to be as durable and permanent as possible, and resistant to weathering and wear from traffic. The removal of such striping is typically required when the road is to be resurfaced or if the indication is to be changed. The removal of such stripes is typically performed by use of abrasive wheels, grinding teeth, or the blasting of abrasive particles against the material to be removed. However, the use of these carbide teeth and grinding wheels results in an undesirable trench or groove in the road.

When polymers such as paint are used for roadway marking, the surface of the pavement is penetrated from ⅛-⅜ inch, so that mere surface removal of the marking material is not sufficient to remove the marking. Therefore, current pavement marking removal machines often employ various forms of cutting devices to remove the marking material, as well as a portion of the underlying layer of pavement material in order to effectively remove painted lines.

For example, one type of cutting machine is disclosed in U.S. Pat. No. 5,236,278 known as a “Road Pro” grinder manufactured by Dickson Industries, Inc. This type of machine employs parallel passive shafts that extend between circular rotating end plates. Hardened steel star wheels are carried on the parallel passive shafts, and these star wheels strike and abrade the pavement surface. While this type of device is effective for removal of markings, they often create excessive heat which may melt thermoplastic materials causing equipment to gum up.

Another approach to pavement marking removal is the use of diamond saw blades arranged to make a dado cut. Still other types of machines use grinders or shot blast as described in patent Registrations U.S. Pat. Nos. 4,753,052; 4,376,358; 3,900,969; 4,336,671; 3,977,128 and 4,377,924. Unfortunately, these devices must remove a portion of the pavement material to effectively remove the marking, thereby leaving unsightly and potentially dangerous grooves in the pavement.

NLB Corporation markets a high pressure water jet system for removing paint from pavement under the name “STARJET”. The STARJET system includes a blast head frame mounted on an attachment to the front bumper of a prime-mover truck. Casters support the frame for movement over the pavement and the path of the blast head is controlled by the driver steering the truck. Because of the position of the driver and the cab body of the prime-mover, it is difficult for the operator to see the blast head's position with regard to the stripes on the pavement. Obtaining clear vision requires the driver to lean out of the driver's side window, resulting in fatigue and other non ergonomically efficient factors. Positioning the blast head to the passenger side of the prime mover is performed manually with some difficulty and greatly complicating the driver's ability to view the path of the blast head. In addition, due to the length of the extension holding the blast head, the angular off-set, and the swivel of the casters, the movement of the wheel of the truck is not directly related to the path of the blast head further complicating operation.

NLB Corporation also has another system marketed under the mark “STRIPEJET”, that is a self propelled tractor with a blast head on the front of the tractor. The blast head has a shroud and high pressure inlet without a vacuum recovery. A problem associated with the STRIPEJET device relates to the construction of the blast head mounting assembly. The mounting assembly includes a rigid track mounted transversely across the front of the tractor. This construction makes the tractor too long for transport on a truck in a transverse orientation. Transport of the tractor aligned with the longitudinal centerline of the truck requires a substantial amount of bed space, making a one truck stripe removal system impracticable.

BLASTERS Corporation markets a high pressure water device which is mounted on a truck similar to the STARJET device. Yet another model appears to be a self-powered four wheeled tractor, similar to a grass mower, which supports a driver and is connected to the prime-mover by high pressure lines for delivery of high pressure water to a blast head. The blast head is mounted to the front portion of the tractor.

Like the other systems currently available, the construction of the blasting head and mechanisms utilized to maneuver it prevent the tractor from being transported on a truck in a transverse orientation with respect to trucks longitudinal centerline. This construction necessitates the need to have multiple trucks and/or trailers to complete the assembly.

One problem with the prior art is the inability to place a suitable amount of equipment upon the bed of a single truck to complete a marking removal task. A portion of this shortcoming stems from the inability to orient a tractor in a transverse manner with respect to the longitudinal centerline of the truck for transport. Another reason relates to the type of water and vacuum tanks utilized in the prior art. All of the known prior art utilizes cylindrical or elliptical tanks for water transport and storage, as well as vacuum recovery. As such these tanks occupy a significant amount of bed space, which obviously limits the amount of equipment that can be transported on a single truck.

Marking removal systems such as those described above typically include a water tank, a vacuum tank, a high pressure water pump which utilizes an internal combustion engine, a vacuum pump which also utilizes an internal combustion engine and a tractor with a blast head. Utilization of standard water and vacuum tanks makes a single truck system impracticable. Because of this the prior art uses multiple trucks and or trailers to transport enough equipment to complete a job. Therefore, constructing a system capable of being transported on a single truck bed would provide a distinct economic advantage.

### SUMMARY OF THE PRESENT INVENTION

Briefly, disclosed is a cleaning system for removing coatings from a hard surface by high pressure liquid. The system employs a combination liquid and vacuum reservoir connected to a high pressure pump for directing ultra high pressure water through a blast head mounted on a self-propelled mobile frame. The mobile frame is a self-propelled tractor wherein the blast head and tractor are of a size for transport transversely on a truck bed. The cleaning system is preferably mounted on a single truck or in an alternative embodiment; an auxiliary water tank may be pulled behind the truck on a trailer. In either embodiment the truck is tethered to the tractor during operation. The truck bed includes a ramp sized to support the tractor for docking and transport.

It is an objective of this invention to provide a vacuum recovery truck mounted stripe removal system having a compact unit for safe, fast over-the-road travel to job sites in a single truck construction.

It is another objective of this invention to provide a high pressure water jet for removal of paint or other coverings and a vacuum recovery system for the water and debris being generated.

It is a further objective of this invention to provide a rectangular holding tank system for a stripe removal system.

It is still another objective of this invention to provide a holding tank for a stripe removal system wherein the tank system includes a water tank and a vacuum tank in a single enclosure.

Still yet another objective of this invention is to provide a holding tank system for a stripe removal system wherein the vacuum tank includes a filter bag for containment of the debris generated while allowing the water to be disposed of separately.

It is a further object of this invention to provide a holding tank system for a stripe removal system including a plurality of filter bag retention hooks which allow the filter bag to be retained while the tank is in generally level position while allowing the bag and any contents to be dumped by tilting the tank.

It is yet another object of this invention to provide a collection/filter receptacle for the removed materials for ease of disposal and the release of filtered wastewater. This allows an operator to easily regain all of the available capacity not occupied by paint or road debris within the vacuum chamber by simply releasing a dump valve. All of the solid debris is retained until such time as the vacuum chamber is completely full. The amount of capacity able to be regained will be continually diminished as the vacuum tank fills with debris, and will eventually reach a point of inefficiency at which point it must be dumped. When the material is dumped, it is dumped as a semi-dried, dewatered debris in which the wastewater is not mixed with the debris.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

While the novel features of the invention are set forth with particularity in the appended claims, the invention, both as to organization and content, will be better understood and appreciated from the following detailed description, taken in conjunction with the drawings, in which:

FIG. 1 is a side view of the stripe removal system;

FIG. 2 is a perspective of the stripe removal system in operation with the blast head deployed;

FIG. 3 is a front view of the blast head and tractor;

FIG. 4 is perspective of the articulated link;

FIG. 5 is a side view of the articulated link with a portion of the boom in a stowed position;

FIG. 6 is a side view of the liquid reservoir and sump; FIG. 7 is a perspective of the vacuum tank and waste removal system;

FIG. 8 is a side view of the single truck stripe removal system; and

FIG. 9 is a sectional side view taken along line 1-1 of FIG. 7.

### DETAILED DESCRIPTION OF THE INVENTION

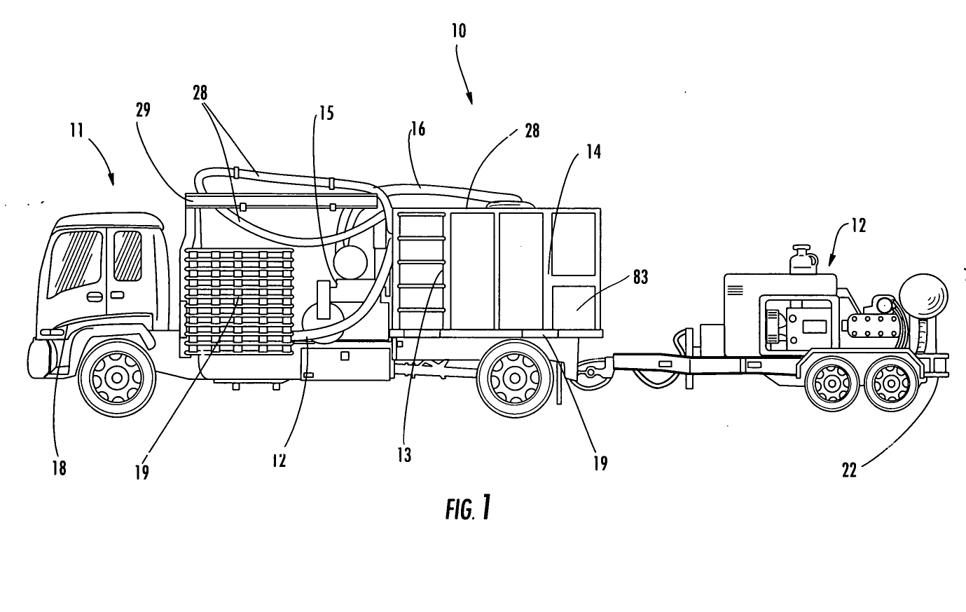

The paint removal system 10, shown in FIG. 1, includes a prime-mover truck 11 and a trailer 12. The truck has a forward cab-over 18 for the driving controls and operator. Mounted on the bed 81 of the truck is the water reservoir 13 and the sump 14 or vacuum chamber. The reservoir and sump are interconnected by a strategically positioned duct for continuous dumping of filtered wastewater when operating from a fixed position where liquid is supplied to the high pressure pump by a means other than the reservoir 13.

The sump 14 is positioned on the rear portion 82 of the bed 81. The rear portion 82 of the bed is pivotally mounted on the truck frame and hydraulicly powered to tilt in the vertical plane permitting dumping of the contents of the sump 14. The sump 14 is connected to the vacuum pump 15 by hose 16. The intake of a high power vacuum pump capable of approximately 1100 CFM (cubic feet per minute) is connected to the vacuum tank. The vacuum tank and pump are also mounted on the bed 81 of the prime-mover 11.

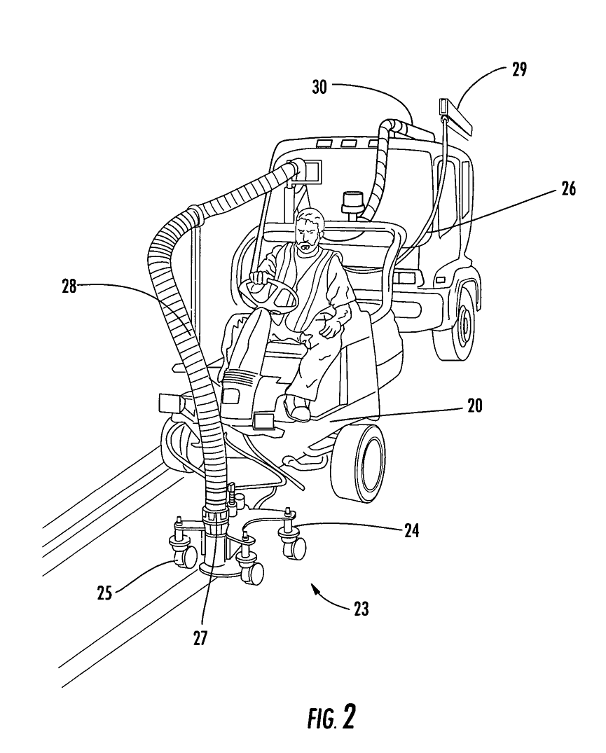

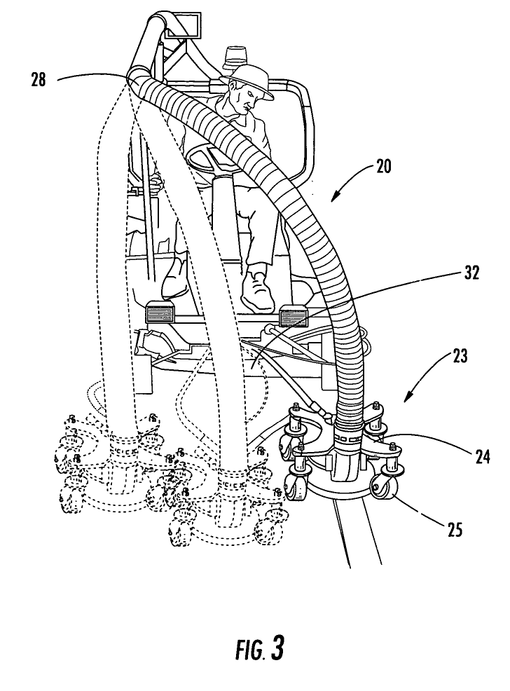

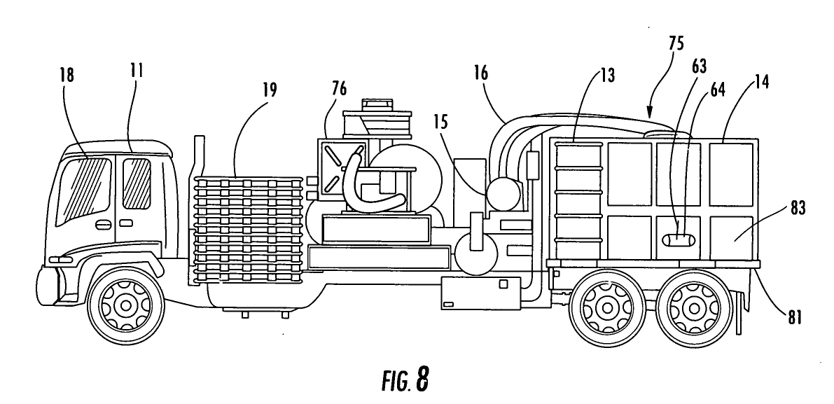

A ramp 19 is hinged to the edge of the bed 81 between the vacuum pump 15 and the cab 18. The ramp can be lowered to provide a pathway for the self propelled tractor 20 (FIGS. 2 and 3). As shown on FIGS. 1 and 8, the ramp 19 is in the stowed or traveling position for highway transport. When the ramp is unfolded it is approximately 9 feet in length.

The trailer 12 is removably attached to the prime-mover through a conventional trailer hitch 21. Mounted on the bed 81 of the trailer is a high pressure fluid pump greater than 25,000-40,000 psi and from 2-15 gallons per minute. A high pressure hose connects the pump with the blast head during operation.

Referring to FIG. 8, a single truck unit is illustrated eliminating the need for a trailer. The single truck unit includes a prime-mover truck 11. The truck has a forward cab-over 18 for the driving controls and operator. Mounted on the bed 81 of the truck is the holding tank 75 including the water reservoir 13 and the vacuum chamber or sump 14. The reservoir and vacuum chamber are interconnected by a strategically positioned duct 64 for continuous dumping of filtered wastewater when operating from a fixed position where liquid is supplied to the high pressure pump by a means other than the reservoir 13.

The sump 14 is positioned on the rear portion 82 of the bed 81. The rear portion 83 of the holding tank 75 is pivotally mounted on the truck frame and hydraulicly powered to tilt in the vertical plane permitting dumping of the contents of the vacuum chamber 14. The vacuum chamber 14 is connected to the vacuum pump 15 by hose 16. The intake of a high power vacuum pump, capable of approximately 1100 CFM (cubic feet per minute), is connected to the vacuum tank. The vacuum tank and pump are also mounted on the bed of the prime-mover 11.

Also mounted on the bed 81 of the truck is a high pressure fluid pump 76 capable of producing 25,000-40,000 psi at 2-15 gallons per minute. A high pressure hose connects the pump with the blast head during operation.

This embodiment may also include a ramp 19 hinged to the edge of the bed 81 between the vacuum pump 15 and the cab 18. The ramp can be lowered to provide a pathway for the self propelled tractor 20. As shown in FIG. 8, the ramp 19 is in the stowed or traveling position for highway transport. When the ramp is unfolded it is approximately 9 feet in length and constructed of a material suitable for traverse by a tractor.

In FIG. 2 the mobile tractor 20 is illustrated in the normal operations position. The tractor is similar to a riding mower with a small engine self propelling the tractor. The blast head 23 has at least one and up to sixteen high pressure nozzles delivering high pressure fluid to the surface to be cleaned. The high pressure nozzle is carried on a chassis 24 mounted on casters 25. A shroud 27 descends from the chassis and surrounds the high pressure nozzle. The blast head is connected to the high pressure fluid pump by high pressure hose 26 and the shroud 27 is connected to the vacuum chamber by vacuum hose 28. The high pressure hose 26 and the vacuum hose 28 is supported by a swinging boom 29 which is mounted on the prime mover 11 shown in FIG. 1 to provide freedom of movement for the tractor and to prevent tangling or running over of the hoses by the prime mover.

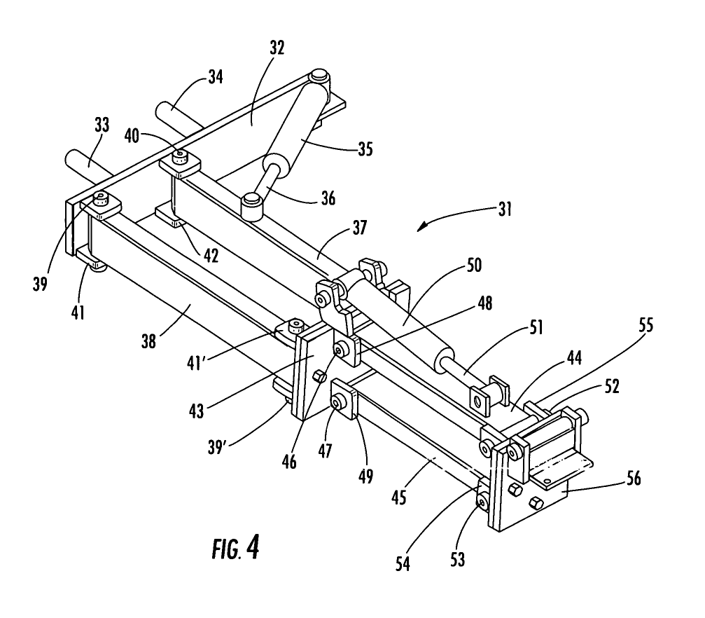

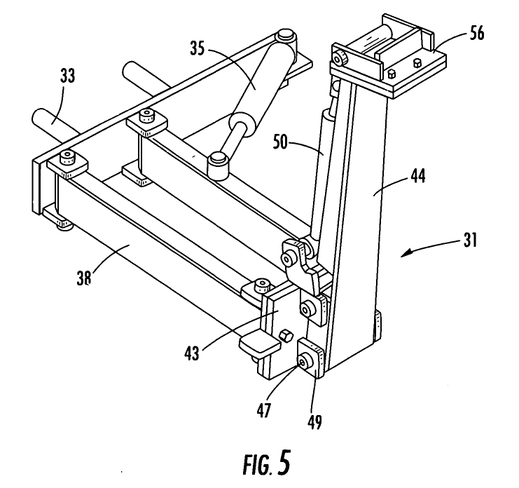

As shown in FIGS. 3-5, the blast head 23 is connected to the tractor 20 by an articulated link 31 which is capable of horizontal movement, as shown in FIGS. 3 and 4, and vertical movement, as shown in FIG. 5. A bar 32 is attached to the tractor frame by rods 33 and 34. The bar 32 is located between the front wheels of the tractor. The horizontal swinging movement of the link results in a widened path of the high pressure nozzle to adjust for different widths or patterns of striping of the surface being cleaned and deviations in direction of the tractor. The horizontal movement is powered by the hydraulic cylinder 35 connected to the bar 32 which may be controlled by the operator moving a joy stick on the tractor. The hydraulic piston 36 is connected to the trailing arms 37 and 38 so that the trailing arms rotating about pins 39 and 40 attached by brackets 41 and 42 on bar 32.

The forward end of the articulated link 31 has a plate 43 connected to the forward ends of trailing arms 37 and 38. The arms 37 and 38 are rotatably connected to the plate by brackets 41′ and holding pins 39′, 40′, respectively. The forward arms 44 and 45 are rotatably connected to the plate 43 to rotate vertically. Pins 46 and 47 extend horizontally through brackets 48 and 49. Another hydraulic cylinder 50 is connected to the plate 43, and the piston 51 is connected to the forward end of the arm 44. As the piston 51 moves, the distance between the surface to be cleaned and the blast head 23 changes. The vertical movement permits elevation changes to accommodate the contours of the surface. Further, the blast head 23 may be raised to the vertical position and then manually flipped up and back reducing the overall length to permit the tractor 20 and blast head 23 to be stowed on a truck bed sideways consuming a space of less than 8′ 6″ for highway travel, shown in FIG. 5. This arrangement also facilitates the operator examining the nozzles and the rotating assembly of the blast head from the operating position. The forward ends of the arms 44 and 45 are attached by pins 52 and 53 to brackets 54 and 55 to prevent binding as the arms are manipulated. The brackets are mounted on a blast head attachment plate 56.

A blast head attachment plate 56 is removably connected to the chassis 24 of the blast head 23 to provide support and control of the blast head from the tractor through the link 31.

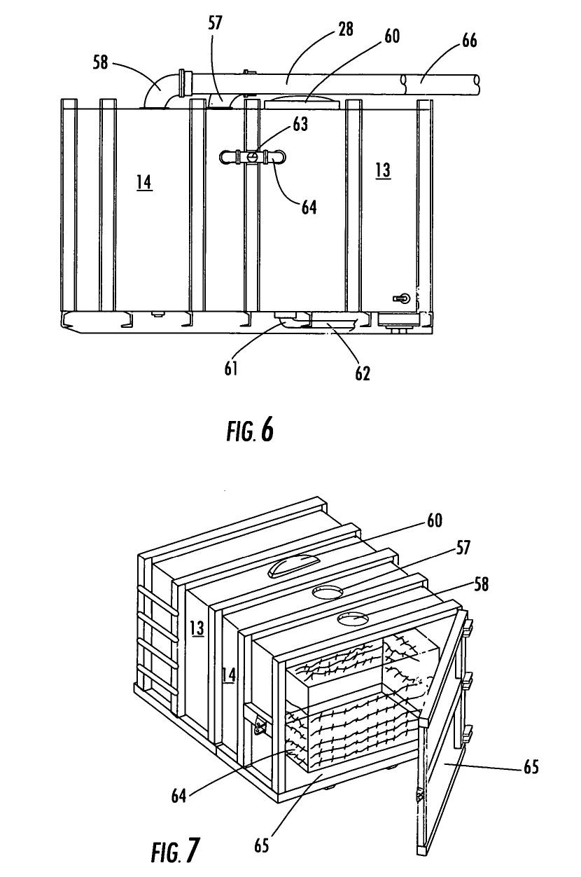

The holding tank 75, including the liquid reservoir 13 and the vacuum chamber 14, is shown in FIG. 6. As illustrated, the liquid reservoir and vacuum chamber have a common enclosure with an internal partition dividing them. The vacuum chamber 14 has an inlet 57 for connection by hose 28 to the vacuum shroud 27. An outlet 58 is connected to the vacuum pump hose 16. The liquid reservoir has a hatch 60 for inspecting and cleaning the reservoir with approximately 600-1500 gallons of liquid. An outlet 61 is connected to a low pressure pump by a low pressure suction hose 62. The low pressure 12-volt pump (not shown) may be used to pump water out of the reservoir 13 back to the high pressure pump 76 at about 40 psi and up to 20 g.p.m. A recycling valve 63 is mounted in a connector pipe 64 having one end opening into the reservoir 13 and the other end opening into the sump 14. The connector is located near the bottom of the vacuum chamber and reservoir to allow for some settling of debris in the vacuum chamber. The valve 63 opens or closes the connection.

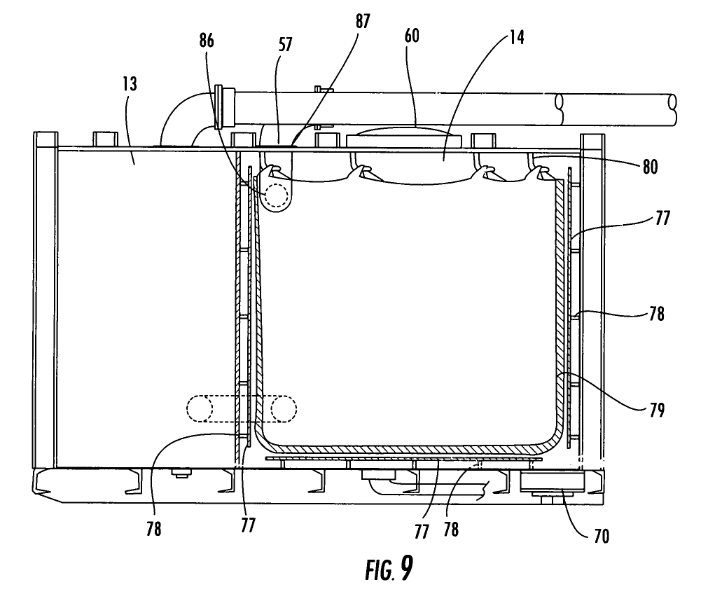

Referring to FIGS. 7 and 9, the vacuum chamber 14 is shown with the rear door 65 open for unloading the porous enclosure 84. The door includes a seal (not shown) to maintain the negative pressure therein during operation. The porous enclosure may be a wire screen or mesh box sized to fit within the vacuum chamber 14. In an alternative embodiment shown in FIG. 9, the porous enclosure is replaced by a plurality of perforated plates 77. The perforated plates are secured to an inner surface of the sump panels with stanchions 78. Wire mesh or expanded metal may be utilized in place of the perforated plates without departing from the scope of the invention. An additional filter bag 79 having between 5-200 micron porosity may be inserted into the porous enclosure 64. Alternatively, the filter bag may be supported in a substantially open position utilizing a plurality of hooks 80 secured to an inner surface of the vacuum chamber. The hooks are preferably constructed and arranged to secure the bag while the sump is in a level position while allowing the bag and any contents to be automatically released when the sump is in a tilted position. It should also be noted that the hooks could be replaced with other mechanical or mechanical/electrical means suitable for retaining the bag in an open position during use while allowing the bag and any contents therein to be automatically released for disposal thereof.

The dimensions of the porous enclosure 64 are somewhat less than the interior of the vacuum chamber which provides a marginal area 85 between the porous enclosure and the interior walls and floor of the vacuum chamber which provides an exit path for filtered water through valve 70. The inlet 57 empties into the porous enclosure 64, thereby preventing coatings from being entrained in the vacuum system. One side of the holding tank enclosure is hinged and latched to permit entry into the vacuum tank or removal of the filter bags. By opening the vacuum chamber door and raising the dump bed of the truck, the waste material can be easily and quickly removed without prolonged interruption of the operations. The filter bag is the disposal container, and is dumped with the material. A permanent filter material can also be utilized which requires cleaning after each use but does not waste a filter bag each time it is dumped.

In operation, the process for using the disclosed equipment in a mobile operation for stripe removal:

1. Connection valve 63 remains closed. Water tank 13 is used only as a fresh water supply and is not placed under vacuum at any time.

2. Filter material 84 positioned in the vacuum tank at a distance off the walls and floor of the tank. A filter “bag” 79 may also be hung by hooks 80 from the top panel to produce even cleaner waste water.

3. The vacuum tank or sump 14 is placed under vacuum by starting the diesel powered vacuum pump which is connected by an air outlet hose 57 to the vacuum tank.

4. As stripe material is removed creating a slurry of water and debris, the mixture is drawn through the inlet hose into the vacuum tank being trapped in the filter.

5. When the vacuum tank reaches its full capacity, a shutoff ball 86 is forced upwards toward the air outlet hose and makes contact with a ball seal 87 causing loss of tank vacuum.

6. The drain valve 70 is then opened on the vacuum tank. The drain permits water to drain through the filter material and into the open cavity between the walls and floor allowing an exit from the drain.

7. The connection valve 63 is closed allowing for a capacity equal to the capacity previously occupied by dirty water, only the debris slurry remains inside the tank.

8. Steps 1-7 are repeated until the strip is removed.

9. Opening of a door to the vacuum container, allows for a removal of all debris captured in the filter.

The instant invention may also be used in a non-mobile setting in continuous operation as follows.

1. The connection valve 63 remains open except when it is necessary to dump the water tank. The water tank is used as an overflow vacuum tank and is under vacuum much of the time.

2. Filter material 84 is positioned in the vacuum tank at a distance off the walls and floor of the tank. A filter “bag” 79 may also be hung by hooks 80 from the ceiling to produce even cleaner waste water.

3. Vacuum tank or sump 14 is placed under vacuum by starting the diesel powered vacuum pump which is connected by the air outlet hose 57 to the vacuum tank. The water tank 13 is under vacuum as well by way of connection valve 63.

4. As stripe material is removed, creating a slurry of water and debris, the mixture is drawn through the inlet hose into the vacuum tank being trapped in the filter.

5. As the debris and water level rise to the level of the connection valve, the water will begin flowing through the connection valve into the water tank. The water in the water side tank will be filtered water as the water has had to first flow through the filter material to reach the connection valve.

6. When the waste water has reached the level of the connection valve it will be visible to the operator through a strategically positioned sight glass. At that point, without shutting down the vacuum or the operation, the operator closes the connection valve which releases the water side tank from vacuum.

7. Next, the operator must open the drain valve on the water tank to release the waste water being held there.

8. After the water tank has drained completely, the water side drain valve must be closed.

9. The connection valve is reopened allowing wastewater to flow freely into the water tank.

10. Repeating of steps 1-9 while never shutting down or affecting the blasting operation whatsoever. This may be continued until the vacuum tank is full of debris.

11. It is now necessary to shut off the vacuum power unit and open the drain valve on the vacuum tank. This allows the water to drain through the filter material, into the open cavity between the walls and floor, and exit the drain. This allows the debris to dewater.

12. Opening of the vacuum door allows for a release of all material to repeat the process.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A rectangular transportable holding tank system, comprising:
a holding tank having a floor panel, a top panel, a front side wall between the floor and the top, a left side wall between the floor and the top, a right side wall between the floor and the top and a rear opening between the floor and the top;
a door hingedly secured to said right side wall and configured to enclose said rear opening in a watertight manner;
an inlet for allowing a combination of air, water and debris to enter said tank;
a first outlet for connection to a source of vacuum;
a plurality of hooks secured within said tank, said hooks constructed and arranged to secure a bag in a substantially open position within said holding tank, said bag positioned to receive said combination of air, water and debris entering said inlet, said bag constructed and arranged to retain said debris while allowing said air and said water to flow through said bag.

2. The transportable holding tank system of claim 1 wherein said holding tank is constructed and arranged to tilt, whereby a front portion of said tank raises to a position higher than a rear portion of said tank.

3. The transportable holding tank system of claim 2 wherein said plurality of hooks are constructed and arranged to release said bag when said tank is in said tilted position.

4. The transportable holding tank system of claim 1 wherein said holding tank includes a second outlet for releasing water from said holding tank, said second outlet positioned to allow substantially all water accumulated in said holding tank to drain outwardly therefrom.

5. The transportable holding tank system of claim 4 wherein said second outlet includes a valve, said valve being selectively positionable between an open position and a closed position.

6. The transportable holding tank system of claim 1 wherein said door is hingedly secured to said left side wall and configured to enclose said rear opening in a watertight manner.

7. The transportable holding tank system of claim 1 wherein said door is hingedly secured to said top wall and configured to enclose said rear opening in a watertight manner.

8. The transportable holding tank system of claim 1 wherein said holding tank includes at least one dividing member attached to said floor, said top, said left side wall and said right side wall in a watertight manner to define a first vacuum tank and a second water tank.

9. The transportable holding tank system of claim 8 wherein said first vacuum tank and said second water tank are connected via a conduit.

10. The transportable holding tank system of claim 9 wherein said conduit includes a valve, said valve selectively positionable between an open position, whereby fluid is allowed to flow through said conduit, and a closed position, whereby fluid is prevented from flowing through said conduit.

11. The transportable holding tank system of claim 10 wherein said valve is positioned in said closed position to allow said first holding tank to be utilized for vacuum recovery of air, water and debris and said second holding tank is utilized for storage of water.

12. The transportable holding tank system of claim 1 wherein said floor panel, said top panel, said front side wall, said left side wall and said right side wall define an outer holding tank wall, wherein at least one of said floor panel, said front side wall, said left side wall or said right side wall include an inner wall spaced inwardly from an inner surface thereof to define an air space therebetween, wherein said inner wall is constructed and arranged to prevent said bag from sealing against at least one of said floor panel, said front side wall, said left side wall or said right side wall.

13. The transportable holding tank system of claim 12 wherein said at least one inner wall is perforated.

14. The transportable holding tank system of claim 1 wherein said floor panel, said front side wall, said left side wall and said right side wall each include an inner wall spaced inwardly from an inner surface thereof to define an air space therebetween, wherein said inner walls are constructed and arranged to prevent said bag from sealing against said floor panel, said front side wall, said left side wall and said right side wall.

15. The transportable holding tank system of claim 14 wherein said at least one inner wall is perforated.

16. The transportable holding tank system of claim 1 wherein said first outlet includes a valve constructed and arranged to shut off said source of vacuum when liquid inside said holding tank reaches a predetermined level.

17. The transportable holding tank system of claim 16 wherein said first outlet valve is a float valve.

18. The transportable holding tank system of claim 1 wherein said left side panel includes at least one visual indicator, said at least one visual indicator constructed and arranged to allow an operator to visually determine the level of liquid contained within said holding tank.

19. The transportable holding tank system of claim 8 wherein said left side panel includes at least two visual indicators, wherein one of said visual indicators is constructed and arranged to allow an operator to visually determine the level of liquid contained within said first vacuum tank and wherein one of said visual indicators is constructed and arranged to allow an operator to visually determine the level of liquid contained within said second tank.

20. The transportable holding tank system of claim 1 wherein said holding tank is sized for mounting on the bed of a truck.

21. A process of utilizing a holding tank for removal of roadway markings comprising the steps of:
1. providing a holding tank having a vacuum tank portion and a water tank portion with a connection valve therebetween;
2. closing of said connection valve;
3. inserting a filter bag in said vacuum tank;
4. creating a vacuum in said vacuum tank by use of a vacuum pump powered by an internal combustion engine;
5. directing ultra high pressure water from said water tank at a material to be removed creating an air, water and debris slurry, said slurry drawn into said vacuum tank, said slurry being trapped in said filter bag.
6. breaking of the vacuum when said vacuum tank reaches full capacity;
7. draining water from said vacuum tank through said filter bag; and
repeating steps 1-8 until said filter bag is filled.

22. A process of utilizing a holding tank for removal of roadway markings of claim 21 including the steps of:
1. opening an access door to said vacuum tank and
2. tilting said holding tank to dump said filled filter bag outwardly therefrom.

23. A process of utilizing a holding tank for removal of roadway markings comprising the steps of:
1. providing a holding tank having a vacuum tank portion and a water tank portion with a connection valve therebetween;
2. opening said connection valve;
3. inserting a filter bag in said vacuum tank;
4. creating a vacuum in said vacuum tank as well as said water tank by use of a vacuum pump powered by an internal combustion engine;
5. directing ultra high pressure water at a material to be removed creating a debris slurry, said slurry drawn into said vacuum tank being trapped in said filter bag.
6. allowing water to pass from said vacuum tank through said connection valve to said water tank when the water level rises to the level of said connection valve;
7. closing of said connection valve releasing vacuum from said water tank;
8. draining of water from said water tank via a drain valve;
9. closing said drain valve;
10. opening said connection valve;
11. repeating steps 1-10 until said filter bag is filled.

24. A process of utilizing a holding tank for removal of roadway markings of claim 21 including the steps of:
1. opening an access door to said vacuum tank and
2. tilting said holding tank to dump said filled filter bag outwardly therefrom.

25. A mobile stripe removal system comprising in combination:
a truck, said truck including a prime mover and an elongated frame;
a rectangular transportable holding tank tiltably mounted on said frame, said holding tank including, a floor panel, a top panel, a front side wall between the floor and the top, a left side wall between the floor and the top, a right side wall between the floor and the top and a rear opening between the floor and the top, a door hingedly secured to said right side wall and configured to enclose said rear opening in a watertight manner, an inlet for allowing a combination of air, water and debris to enter said tank, a first outlet for connection a source of vacuum, a plurality of hooks secured within said tank, said hooks constructed and arranged to secure a bag in a substantially open position within said holding tank, said bag positioned to receive said combination of air, water and debris entering said inlet, said bag constructed and arranged to retain said debris while allowing said air and said water to flow through said bag for retention in said tank, a dividing member attached to said floor, said top, said left side wall and said right side wall in a watertight manner to define a first vacuum tank and a second water tank;
a water pump secured to said frame and selectively connectable to said second water tank, said water pump powered by an internal combustion engine, said pump capable of supplying at least two gallons of water per minute pressurized to at least twenty five thousand pounds per square inch.
a vacuum pump secured to frame, said vacuum pump powered by an internal combustion engine for creating a negative pressure within said first vacuum tank;
a ramp pivotally connected to said frame, said ramp movable between a lowered position to provide a pathway for a self propelled tractor and a raised position for movement of said truck.
